(19) United States
(12) Patent Application Publication
(10) Pub. No.: US 2006/0218492 A1
(43) Pub. Date: Sep. 28, 2006

(54) Copy and paste with citation attributes

(76) Inventor: Jose Olav Andrade, Aptos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/087,202

(22) Filed: Mar. 22, 2005

(51) Int. Cl. G06F 17/00

(52) U.S. Cl. 715/523

(57) ABSTRACT

A command to copy or cut selected data from a source file is received. In response to receiving the command to copy or cut the data, citation information associated with the data is automatically collected. The data and the citation information are then copied into a copy buffer. A command to insert the data into a destination file is received. In response to receiving the command to insert, the data and its associated citation information is automatically transferred from the copy buffer into the destination file. In one aspect, at least a portion of the citation information is displayed as a reference associated with the inserted data within the destination file.

### TECHNICAL FIELD

This disclosure relates generally to user interfaces and information management in digital processing systems, and in particular, relates to management of citation information when copying and/or pasting or otherwise storing digital content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2005, Apple Computer, Inc., All Rights Reserved.

### BACKGROUND INFORMATION

Users of modern data processing systems, such as general purpose computer systems, often desire to transfer information between different data sources, for example, by copying data from one source and pasting the data into another source. A common example is a user who uses the Internet to research and acquire information or data, which is later compiled and used in forming a new document, such as a text document or a webpage. Most computer operating systems and applications facilitate such copying and pasting through graphical user interfaces. Such user interfaces may for example, allow a user to easily copy then paste selected text through use of commands issued by a keyboard or pointing-device. The ease by which a user is able to copy text or other data, for example from web pages and other documents accessible through the Internet, has resulted in an environment where the original source of information is often undocumented, unclear, or potentially cited improperly. This presents difficulties in managing not only intellectual property rights (e.g. Copyright) to copied data, but also the more practical matter of correctly ascribing authorship or origin of copied information. Furthermore, in some situations, incorporating copied content into new works, without properly attributing the author or source of the material, could potentially result in plagiarism.

Typically, a user does not necessarily wish to obscure the origin of copied data when using the copied data in a derivative work. FIG. 1 illustrates a prior art example of the conventional process which is taken by a conscientious user who wishes to appropriately cite the origin of text copied, for example, from an Internet web page. The user first manually copies the selected text from the webpage 102. This copied text is temporarily stored in an area of memory on the computing system referred to as a copy buffer or “clipboard.” The user then manually pastes the selected text from the clipboard into, for example, a text document of a word processing application 104. Next, to appropriately cite the source of the copied text, the user manually copies or gathers the citation information of the webpage, such as the uniform resource locator (URL) of the webpage from which the text was copied 106. It should be noted that to cite the webpage or source document properly, the user would need to be aware of various standardized citation formats, and gather the appropriate information for an accurate citation. This copied information is stored in the clipboard, then the user then manually pastes the copied URL from the clipboard into the document 108. Further, since webpages (and Internet content in general) are often dynamic and transient sources subject to frequent change, the user may then need to manually input additional citation information pertaining to the copied text 110, such as the time and date at which the information was collected.

FIG. 2 illustrates a copy buffer 202 and a paste result 204 for a prior art copy and paste operation, such as that found in some conventional computer operating systems. The copy buffer 202 and paste result 204 are illustrative of the results of the operations represented by blocks 102 and 104 of FIG. 1. Copy buffer 202 represents a section of memory used to temporarily hold data that has been cut or copied from a document for the purposes of transferring the data to another document or another location within the same document. Copy buffer 202 may also be referred to as a “clipboard.” By way of example, the contents of the copy buffer 202 as illustrated in FIG. 2 represent the state of the copy buffer 202 after a user has copied the selected text “there is nothing solid but virtue” 252 from webpage 250. For example, a user may have used a mouse to select (“highlight”) a portion of text from a document such as a webpage 250 or other document, after which the user instructed the computing device to “Copy” (or “Cut” for editable sources) the selected data.

The copy buffer 202 specifies attributes (i.e. characteristics) that describe the copied data and are used to display the copied text. Such conventional attributes include, for example, the content 206 of the copied text itself, the font 208 of the copied text, the font size 210 of the copied text, and the typeface 212 of the copied text. Typically, these attributes as stored in the copy buffer 202 represent the formatting of the copied text; e.g. if the copied text was in 10-point Times New Roman regular font, then these characteristics are stored along with the copied text in the copy buffer 202.

Upon receiving a paste command from the user, the contents of the copy buffer 202 are inserted into a specified location (e.g. another document, such as a text document). Depending on how the user specifies the paste operation to be performed (e.g. paste as formatted text, unformatted text, etc.), and whether the application being pasted to is able to render the specified attributes, some or all of the attributes 206, 208, 210 and 212 specified in the copy buffer 202 may be used to render the text 206 as a paste result 204 in the target application. In the example illustrated in FIG. 2, the paste result 204 displays the pasted text 214 with font, size, and face formatting, as the pasted text would appear in an application capable of rendering the attributes specified in the copy buffer; i.e. the text 214 is displayed in Times New Roman font, 10 point, regular face. A user wishing to add citation information for the copied/pasted text would then need to take additional steps as discussed above with respect to FIG. 1.

As mentioned above, the target application (i.e. the application for a document into which the copied material is being pasted into) may or may not support rendering of the pasted data (e.g. text) according to the attributes specified in the copy buffer. For example, when copied text is pasted into common word processing applications, such as Microsoft® Word X (available from Microsoft Corporation), the application will typically associated the style attributes (e.g. font, size) in the copy buffer with the pasted text. Thus, the application retains the formatting of the copied text. However, some plain text editing applications, such as BBEdit 7.1 (available from Bare Bones Software, Inc.), will not associate style attributes when inserting copied text into a document, and will merely paste a plain text version of the copied text without attributes.

The manual collection or input of citation data by conscientious users for copied/pasted data, when performed correctly and accurately, serves the purpose of accrediting the source of copied information. However, this task requires forehand knowledge of appropriate citation formats, making it unlikely for many users to correctly cite sources, if at all. Furthermore, even with knowledge of how to cite a source appropriately, these tasks are tedious and error-prone, making proper citation the exception, rather than the rule, when collecting digital information from easily copied sources, such as Internet web pages or digital documents.

### SUMMARY OF THE DESCRIPTION

The present invention relates to incorporating citation attributes into copied digital content for immediate use in paste operations (and the like) or longer-term preservation with the copied digital content. In one aspect, citation attributes may be incorporated into copy and paste (insert) operations or cut and paste operations. When copying digital information (including but not limited to text, image, audio, and video data), it is often useful to track the source of the information, including both the immediate source (e.g. a webpage from which text is copied) and the original source (e.g. a book in which the text was originally published) of the copied information. Conventional methods require a user to manually track and insert citation information into documents when copying digital content. Embodiments of the present invention provide for the automatic collection of citation information from electronic documents.

In one aspect, a command to copy or cut selected data from a source file is received. In response to receiving the command to copy or cut the selected data, citation information associated with the selected data is automatically collected. The data and the citation information are then copied into a copy buffer. In one aspect, the citation information is stored in the copy buffer as attributes for the copied data. The citation information may include information identifying an author, a composer, a title, a date, a time, a publisher, a uniform resource locator (URL), and a subsection. The copied data may be text, image, audio, or video data.

In another aspect, a command to insert the data into a destination file is received. In response to receiving the command to insert, the data and its associated citation information from the copy buffer are automatically transferred into the destination file. At least a portion of the citation information may then be displayed within the destination file. The citation information can be formatted according to a user-specified citation convention, and may be presented as a footnote, endnote, a parenthetical citation, or within a bibliography for the destination file. The user specified citation convention may be modified by the user by selecting one or more parameters which define, at least in part, the user specified convention.

In another aspect, the citation information is stored as metadata associated with the destination file. The citation information may be collected from metadata associated with the source file. In one aspect, the source file is a webpage, and meta tags within the coding of the webpage specify at least a portion of the citation information.

In yet another aspect, metadata from a source document is captured upon copying a portion of the source file. Metadata associated with the specific copied portion of the source file may automatically be collected. In another aspect, metadata for the entire source document may be collected automatically, even though only a portion of the source document content is copied. In addition, metadata including citation information may automatically be copied upon copying a portion of the source file.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates a prior art example of a citation process.

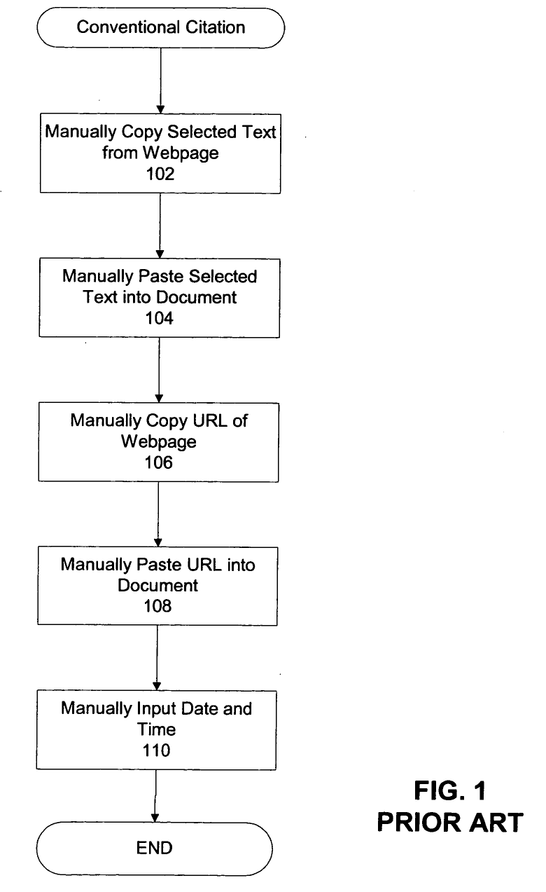

FIG. 2 illustrates a copy buffer 202 and a paste result 204 for a prior art copy and paste operation.

FIG. 3 illustrates embodiments of a copy buffer 302 and a paste result 330 in a system supporting citation attributes for copy and paste operations.

FIG. 4 illustrates an embodiment of a method 400 for copying data with citation attributes.

FIG. 5 illustrates an embodiment of a copy buffer 502 and a paste result 530 in a system supporting citation attributes for copy and paste operations.

FIG. 5A illustrates HTML code for the webpage illustrated in FIG. 5.

FIG. 6 illustrates an embodiment of a method 600 for copying data from a source document having citation metadata therein.

FIG. 7A illustrates an embodiment of an operating environment suitable for practicing the present invention.

FIG. 7B illustrates an embodiment of a computer system suitable for use in the operating environment of FIG. 7A.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Embodiments of the present invention relate to incorporating citation attributes into copied digital content. Conventional attributes for a copied object (e.g. text) usually describe only appearance of the copied object, and are used to render the object being pasted. In one embodiment of the present invention, citation attributes are automatically collected for a copied object. Citation attributes may be used to describe the source of the copied object as a conventional bibliographic entry.

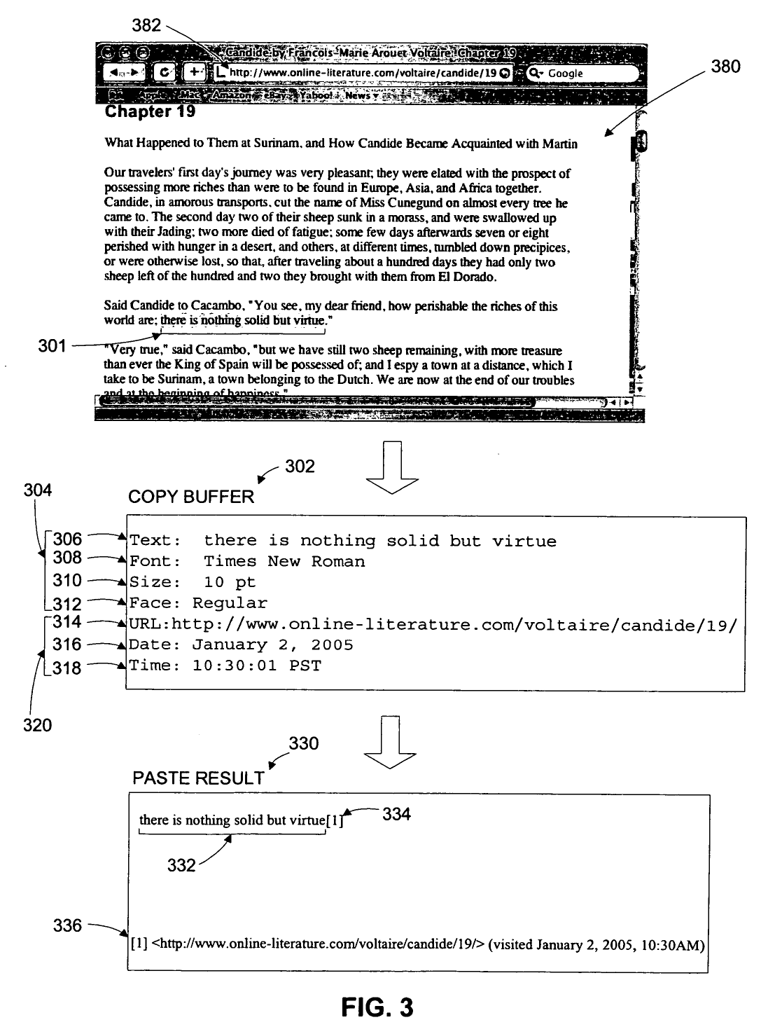

FIG. 3 illustrates an embodiment of a copy buffer 302 and a paste result 330 in a system supporting citation attributes for copy and paste operations. By way of example, the contents of the copy buffer 302 as illustrated in FIG. 3 represent the state of the copy buffer 302 after a user has copied (or otherwise stored) the selected text “there is nothing solid but virtue” 301 from a webpage 380 having a URL (web page address) 382 of http://www.online-literature.com/voltaire/candide/19/, the user having copied the data (i.e. the text was copied from the webpage 380 to the copy buffer 302) on Jan. 2, 2005 at 10:30 AM. As described above, a user may issue a copy command through any of several well known techniques, such as by issuing commands through a keyboard or a cursor control device by selecting (e.g. highlighting) at least a portion of text from the webpage, after which the user instructs the computing device to “Copy” or “Cut” the selected data (e.g. keyboard or mouse issued commands to Copy, drag-and-drop procedures for copying and pasting, etc.). It will be appreciated that various well known input interface devices may be implemented with embodiments of the invention to allow user to issue commands (e.g. copy, cut, and paste commands). Examples of such input interface devices include one or more buttons, a touch screen, a stylus or other pointing device, and a speech recognition interface for receiving voice or spoken commands from a user. Furthermore, in one embodiment, a copy command is issued simultaneously with the selection of the content. For example, in one embodiment, a user may select or highlight text, which is automatically copied into the copy buffer without further user interaction.

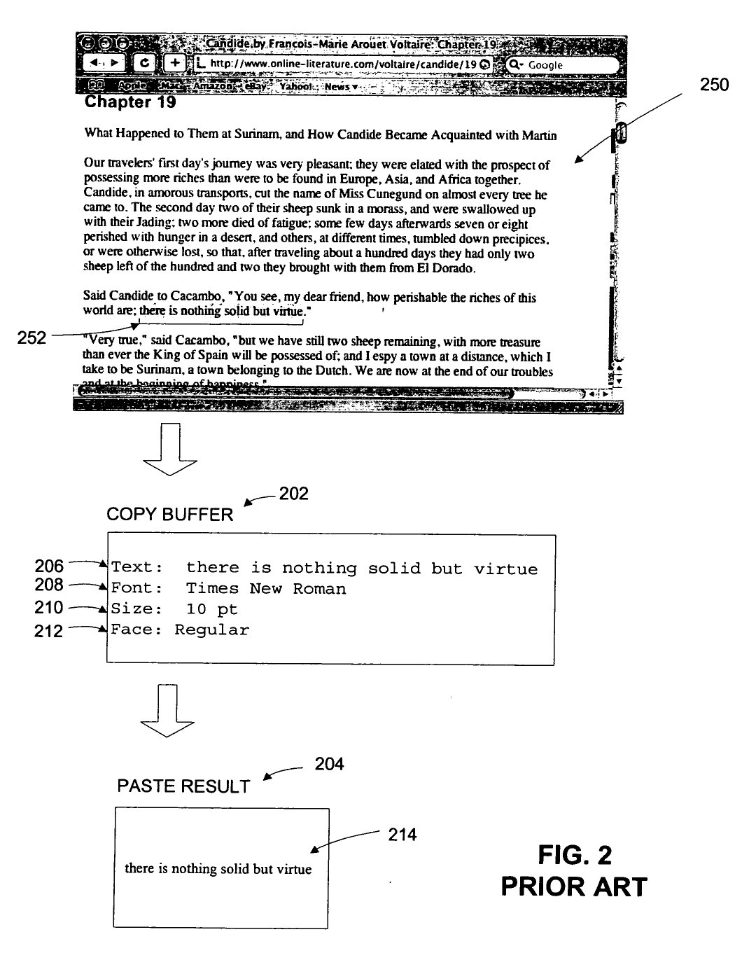

In one embodiment, like the copy buffer 202 of FIG. 2, the copy buffer 302 may specify conventional attributes 304 of the copied data, including the content 306 of the copied text itself, the font 308 of the copied text, the font size 310 of the copied text, and the typeface 312 of the copied text. These attributes as stored in the copy buffer 302 represent the formatting of the copied text; e.g. since the copied text 301 was presented on the webpage 380 in 10-point Times New Roman regular face font, then these characteristics are stored along with the copied text in the copy buffer 302.

However, embodiments of the copy buffer 302 of the present invention include additional attributes for the copied data. In one embodiment, the copy buffer 302 also stores citation attributes 320. The citation attributes 320 describe characteristics of the copied data that may be used to generate a citation for the copied data. A citation is a reference to a source from which a quotation, information, or other data was derived. Citations typically include information useful in locating or identifying a source of the copied data. For example, a book citation may typically include author, title, place of publication, publisher and date of publication; an article citation may typically include author, title, name of periodical, date, and page reference. For formal documents, citations often must be written in a correct format by following the Style Manual of a particular discipline. For example, the field of psychology uses the Style Manual published by the American Psychological Association (APA), and the humanities typically use the citation format specified by the Modern Language Association (MLA). There are different style manuals for a number of disciplines.

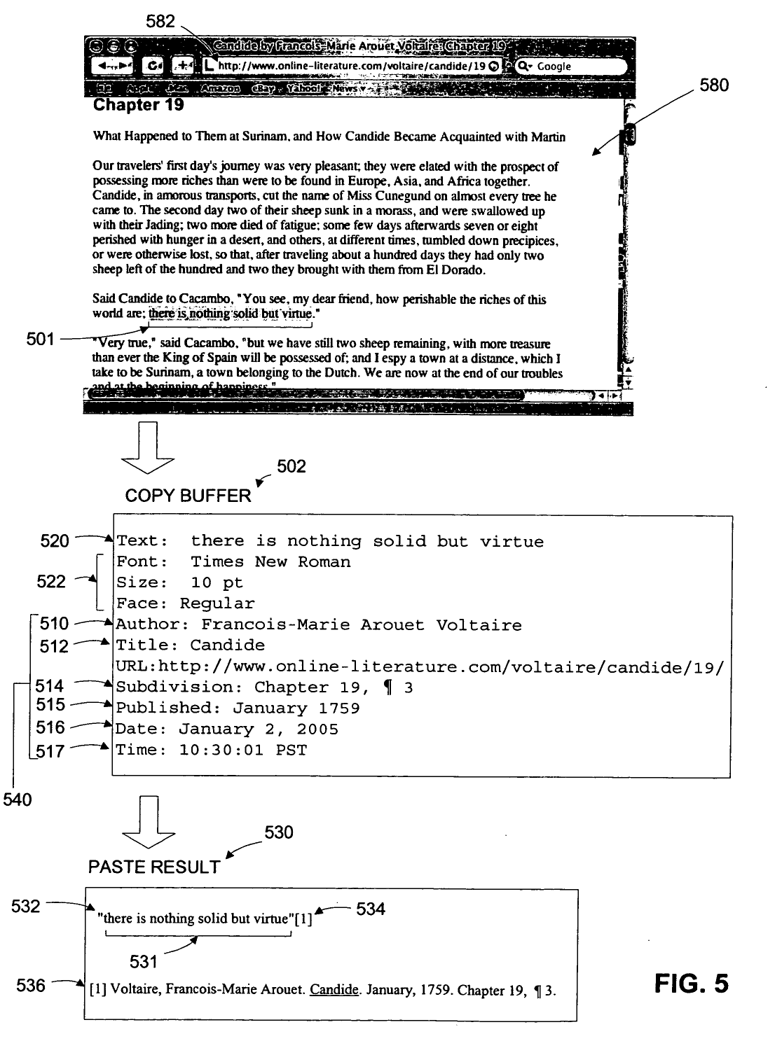

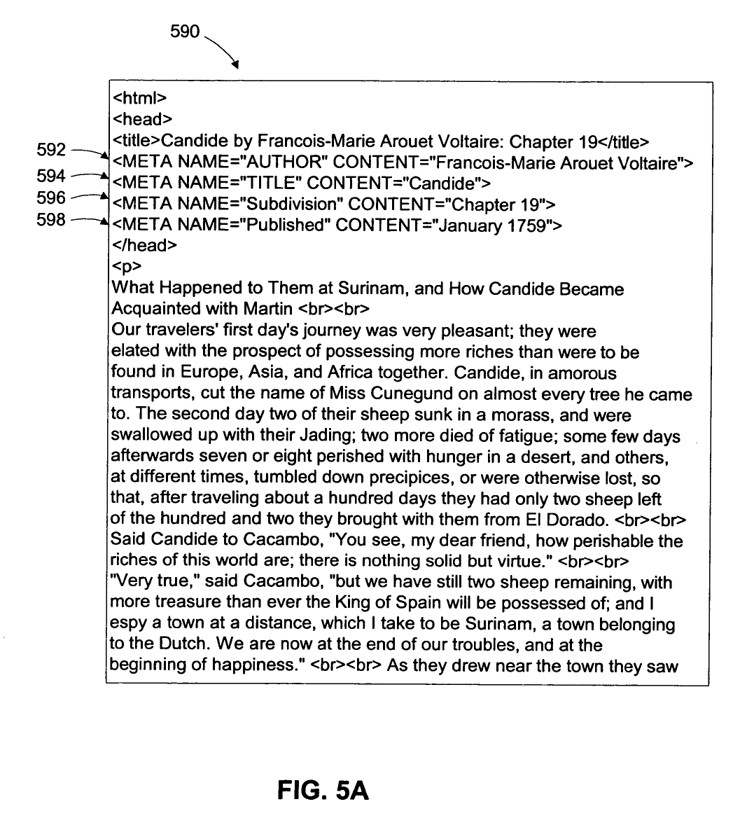

In the embodiment illustrated in FIG. 3, the citation attributes 320 for the copied text 301 include the URL 314 of the webpage 380 from which the text 301 was copied, as well as date 316 and time 318 attributes. In one embodiment, the date and time attributes 316, 318 (i.e. timestamps) represent the date and time at which the user copied the text 301 into the copy buffer 302. In another embodiment, the date and time attributes 316, 318 represent the date and time at which the source webpage 380 was last modified. For example, this information may be specified in metadata for the HTML document for the webpage, or this information may be collected from the physical “last modified” file timestamp of the HTML document for the webpage. In yet another embodiment, the date and time may be derived from the original source of the copied text, as specified by metadata for the copied text of the webpage. This is described in greater detail below with respect to FIG. 5.

It will be appreciated that other citation attributes in addition to or in place of those 320 illustrated in FIG. 3 may be automatically collected into the copy buffer 302. Examples of other citation attributes are described below with respect to FIG. 5. Detailed citation attributes are useful as the immediate source from which material is copied is often not the original source. For example, material posted on an Internet webpage may not have been originally published on that webpage; rather, the material may be a reposting of content that was originally published elsewhere, such as in a book form. In such a case, there is a distinction between the webpage composer, and the author of the content posted on the webpage. Use of appropriate citation attribute tags can be used to recognize this distinction.

Referring again to the embodiment illustrated in FIG. 3, upon receiving a paste command from the user, at least a portion of the contents of the copy buffer 302 are inserted into a specified location, such as a text document. In the embodiment illustrated, the paste result 330 presents the pasted text 332 rendered in accordance with the conventional attributes 304, i.e. the font, size and typeface of the pasted text are rendered as indicated in copy buffer 302. In one embodiment, in addition to presenting the pasted text 332, a footnote reference 334 is associated with the pasted text 332. The footnote reference 334 refers to a corresponding footnote 336 that is also inserted into the text. Thus, in one embodiment, from a single paste or insert command received from a user, multiple insertions result (e.g. the pasted text, a footnote reference, and the footnote itself). Additional formatting, such as the footnote number, the <and> symbols, and the “visited” notation are automatically added as part of the formatting operation upon pasting.

The term footnote includes any note or other reference used to document the source of data, often placed outside of the main text. The term usually refers to notes at the bottom of a page, but may also include endnotes, which are found at the end of the text, and parenthetical notes, which are found within parentheses in the middle of the text, in addition to other known citation conventions associated with copied text or data. The footnote 336 illustrated in the paste result 330 includes the URL of the webpage from which the text was copied, as indicated by the citation attribute 314 in the copy buffer 302. Additionally, the time and date attributes 316, 318 as specified in the copy buffer 302 are also presented in the footnote 336.

It will be appreciated that the appearance of the paste result may vary depending on how the user specifies the paste operation to be performed (e.g. paste as formatted text, unformatted text, etc.), and whether the application being pasted to is able to render the specified attributes. As such, some or all of the attributes 304, 320 specified in the copy buffer 302 may be used to render the text 306 as a paste result 330 into the target application. It will also be appreciated that other types of citation formats are contemplated for use with embodiments of the present invention, including, but not limited to, various formats of footnotes, endnotes, parenthetical notes, bibliographies, etc. Additionally, some characters or formatting will be automatically performed to comply with the specified citation format. For example, although the word “visited” is not in the copy buffer 302 per se, a computing system could be configured to recognize that the date 316 and time 318 attributes represent the date and time the website was visited for purposes of copying the information.

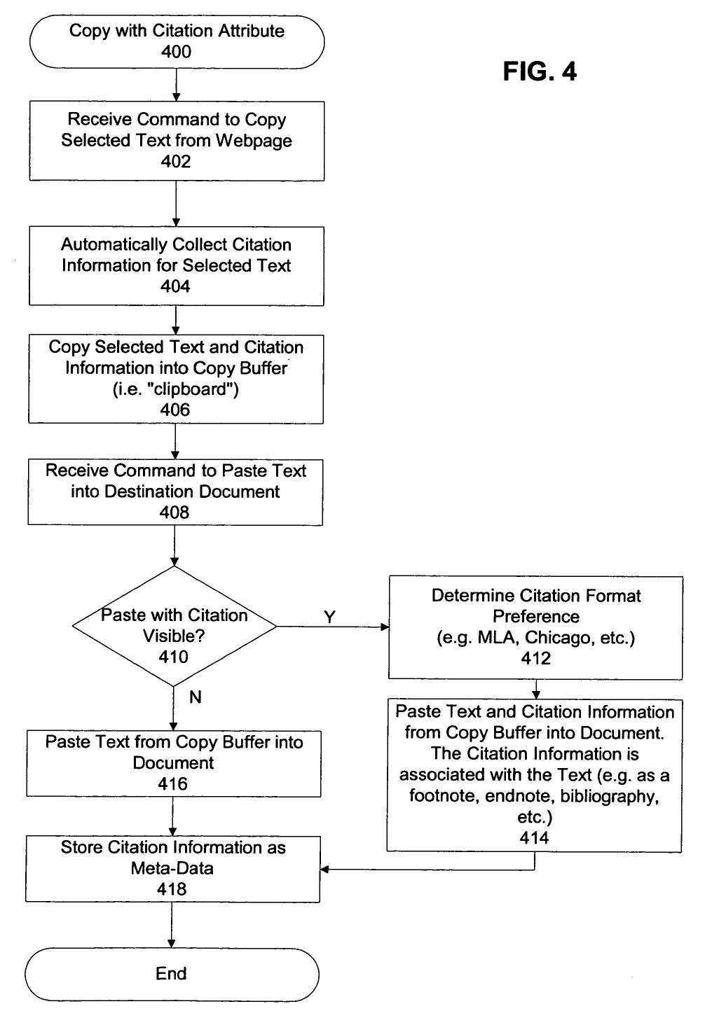

FIG. 4 illustrates an embodiment of a method 400 for copying data with citation attributes. For clarity, the method 400 is described in terms of coping from a webpage; however, it will be appreciated that other types of source documents are contemplated for use with embodiments of the present invention. In one embodiment, the method 400 may be used to generate the copy buffer and paste result of FIG. 3. At block 402, the method 400 receives a command to copy selected text from a webpage. As described above, this command may be issued by a user through an interface device such as a pointing device (i.e. mouse) and/or a keyboard. At block 404, the method 400 automatically collects citation information for the selected text. As described above, this citation information includes information that may be used to identify the source of the copied text, such as, but not limited to, a URL of the webpage, a title of the webpage, a time and date (e.g. last modified date, date of copying, original date of publication, etc.), an author, etc. For example, to collect the URL of the webpage from which the material is being copied from, the method 400 determines the current URL of the webpage for an active window of a web browser application. As another example, the method 400 may collect/read current time/date information from the local computing system on which the method 400 is implemented. In one embodiment, the time/date information may be collected based on the timestamp of the HTML document encoding the webpage being copied from.

In one embodiment, a user may pre-configure what type of citation information is automatically collected at block 404 when performing a copy command. For example, the user may only wish to collect URL information, and may not be interested in the timestamp or last-modified date/time of the webpage being copied from. In another embodiment, all available citation information is automatically collected by the method 400. Selected portions of this citation information are then displayed depending on a user's preference, as discussed below.

Once the available citation information is collected at block 404, the method 400 copies the selected text and the collected citation information into the copy buffer of the computing system (i.e. the clipboard) at block 406. Subsequently, once a user has determined where to insert the copied text, the method 400 receives a command at block 408 to paste (or insert) the copied text into a destination document.

In one embodiment, citation attributes for copied text are implemented using an API (Application Program Interface or Application Programming Interface). An API is a series of software routines and development tools that comprise an interface between a computer application and lower-level services and functions (e.g. the operating system, device drivers, and other low-level software). APIs serve as building blocks for programmers putting together software applications. One such example of an API is COCOA®, an object-oriented application environment designed for developing applications for the Mac OS® X operating system, available from Apple Computer, Inc. NSAttributedString objects are objects within the Cocoa environment that manage character strings and associated sets of attributes (for example, font and kerning) that apply to individual characters or ranges of characters in the string. An association of characters and their attributes is called an attributed string. An attributed string identifies attributes by name, storing a value under the name in an NSDictionary. In one embodiment, specific attribute names are used in conjunction with the NSAttributedString object to assign values to various citation information, such as author, URL, publisher, publication date, etc.

Referring again to FIG. 4, at block 410, the method 400 determines whether to paste the copied text with or without the citation information visible. By visible, it is meant that the citation information is inserted as normal text within the destination document (e.g. footnote 336 of FIG. 3), as opposed to merely inserting the citation information as metadata associated with either the document or the copied text, which is not displayed as normal text in the document. Metadata (i.e. data about data) describes the attributes of an associated information bearing object, such as a document, data set, file, database, image, artifact, collection, etc. A metadata record can include representations of the content, context, structure, quality, provenance, condition, and other characteristics of data. Metadata about a document may be embedded within the document, or the metadata may reside in a separate file that is associated with the document.

In one embodiment, where citation data is pasted as visible text in the destination document, citation information may also still be associated through metadata with the pasted text. In one embodiment, the determination at block 410 is based on a user indicating how the copied text should be pasted, e.g. by issuing a command to paste with or without citation information visible. In another embodiment, as a default, the method 400 may paste either with or without the citation information being visible, as may be indicated by a user's preference.

Where the method 400 determines at block 410 to paste with the citation information visible in the destination document, the method 400 then determines at block 412 how the citation information should be formatted, e.g. according to a user preference. The format of the citation may be a default format, or may be user-specified on an application level or a system-wide level. For example, the user may specify what specific citation attributes should be included in the citation, how the citation should appear (e.g. font, size), in what order the citation attributes should be presented in the citation, where in the document the citation should appear (e.g. as a footnote, endnote, in a bibliography), etc. In one embodiment, the method 400 may format the citation in accordance with a recognized citation style, as may be specified by the user. For example, the user may set a preference for citations to be displayed in accordance with a recognized citation convention, such as for example any of the Modern Language Association (MLA), the American Psychological Association (APA), the Chicago Manual of Style or Turbian citation formats. In one embodiment, should the copy buffer not contain all of the information necessary for creating a citation in the format specified, the method 400 may alert the user, requesting additional information, or alternatively, the method 400 may simply omit the missing information from the citation. In another embodiment, the method 400 may automatically select the format for the citation based on either the source from which the text was copied (e.g. webpage vs. text document), or the type of document into which the copied text is being pasted, as may be specified beforehand by a user (e.g. in a preferences menu for copy/paste operations).

Once the citation format has been determined by the method at block 412, the method 400 pastes the text and citation information from the copy buffer into the destination document at block 414, where the citation information is presented and associated with the text in accordance with the citation format determined at block 412. For example, in one embodiment, the citation information may be presented as a footnote associated with the pasted text, such as is illustrated by the paste result 330 of FIG. 3. Thus, in one embodiment, upon copying information from a source, citation information for the source is automatically inserted into a destination document in response to a command to paste the copied text.

In one embodiment, after pasting the text and citation information into the destination document at block 414, the method 400 stores the complete citation information (as stored in the copy buffer) as metadata associated with either the pasted text and/or the destination document. For example, in one embodiment, the displayed citation information may only display the date which the data was copied from the webpage, and not the exact time (e.g. 10:30 AM); in such a case, the time information is still stored within the metadata associated with the pasted text.

In some cases, a user may not wish to display citation information when pasting selected material into another document. If this is the case, then at block 410, the method 400 determines that the citation material should not be pasted with the copied text, and then at block 416, the method 400 pastes only the text from the copy buffer into the destination document, without displaying the citation information stored in the copy buffer. Although a user may not wish to display the citation information for copied and pasted material, at block 418, the method 400 may nonetheless store the citation information as metadata within the destination document. In one embodiment, the citation data stored in the metadata of the destination document may later be used to, for example, create a bibliography for the destination document. Thus if a user subsequently desires to display footnotes or other citations for pasted material, the preserved citation information allows for visible citations to be generated on the fly or dynamically, by recalling the citation information stored in the document's metadata. In one embodiment, a word processing application may include functionality to allow a user to easily instruct the application to show or hide citation data within a document. In another embodiment, since citation attributes are stored in the metadata associated with the pasted text, citations in various formats can be generated on the fly by the target application. For example, in one embodiment, using the citation information metadata, a user could easily instruct an application to change all footnotes in a document from a first citation format (e.g. MLA) to another citation format (e.g. APA).

It should be noted that in one embodiment, a user may specify that only the copied text not including any of its associated citation information, should be inserted into the destination document. Thus, in such an embodiment, the method 400 may not even insert citation data into the destination document as metadata, although it was previously collected and copied into the copy buffer upon receiving the copy command. However, since the citation attributes remain in the copy buffer, the citation information is preserved (until overwritten), and thus may be used in a subsequent paste operation.

FIG. 5 illustrates an embodiment of a copy buffer 502 and a paste result 530 in a system supporting citation attributes for copy and paste operations. By way of example, the contents of the copy buffer 502 as illustrated in FIG. 5 represent the state of the copy buffer 502 after a user has copied the selected text “there is nothing solid but virtue” 501 from a webpage 580 having a URL 582 of http://www.online-literature.com/voltaire/candide/19/, the user having copied the data (i.e. the text was copied from the webpage 550 to the copy buffer 502) on Jan. 2, 2005 at 10:30 AM.

The contents of copy buffer 502 are similar to that of copy buffer 302 of FIG. 3, except that copy buffer 502 provides additional examples citation attributes that may be used in embodiments of the present invention. In particular, FIG. 5 illustrates citation attributes that are determined based on the substantive content of the source document, rather than extraneous information, such as the web address from which it was obtained.

An author citation attribute 510 describes an author of the copied material. The author information, as well as other citation information, such as the title 512, may be derived from a number of sources. In one embodiment, citation information within the copy buffer 502 may be collected from metadata or other information within the source document. In the case of a webpage as the source document, the hypertext markup language (HTML) coding of the webpage (HTML document, e.g. index.html) itself may include metadata information that may be used to collect citation information, as illustrated in FIG. 5A. The HTML code 590 shown in FIG. 5A illustrates an example of a portion of the HTML coding that is used to render the webpage 580 of FIG. 5. Some webpages include metadata tags identifying characteristics of the document, as well as the content on the page. In one embodiment, these META tags may be used to provide citation information about the webpage content being copied. For example, the HTML coding 590 of the webpage 580 may include the following META tag 592: <META NAME=“AUTHOR” CONTENT=“Francois-Marie Arouet Voltaire”>. The META element NAME specifies a property (here “author”) and assigns a CONTENT value to it (here “Francois-Marie Arouet Voltaire”). Hence, the tag indicates the author of the content on the webpage as being Francois-Marie Arouet Voltaire. Such metadata tags are useful for attributing the original or true source/author of information on the webpage, rather than just identifying the composer of the webpage document.

In one embodiment, a webpage or other document may include various additional metadata tags for indicating various citation attributes describing the content on the webpage, such as, but not limited to, tags identifying the title 594, subdivision 596, original publication date of the content presented on the webpage 598, copyright information, a last revision date of the webpage itself, a publisher of the content, an International Standard Book Number (ISBN) uniquely assigned to a printed book, an International Standard Serial Number (ISSN) (a number which identifies periodical publications as such, including electronic serials), among other types of information used to identify the cited work. The citation attributes may described publicly accessible sources represented by the digital copy. It will be appreciated that other schemas for embedding citation information into various documents and files may be supported by embodiments of the present invention.

In one embodiment, a source document may include metadata which is a reference or pointer to another repository of information, such as a database. For example, where content on a webpage is a reposting of material that was published in book form, the webpage may include metadata identifying an ISBN, ISSN or ASIN (AMAZON Standard Identification Number). For example, by using the ISBN metadata, a computing system could then access a database and pull more detailed (and possibly dynamic) citation information on the webpage content than is stored in the metadata for the webpage. This citation information (which was obtained from a source other than the copied-from webpage) may then be used to fill in various citation attributes in the copy buffer.

Referring again to FIG. 5, in one embodiment, the values associated with the author 510 and title 512 attributes in the copy buffer 502 may be derived from metadata information stored in the document being copied from, as described above. In another embodiment, values for citation attributes, such as for example the subdivision attribute 514 (which specifies the section of a document from which the copied material is taken, such as a page number, a chapter, a paragraph, volume, etc.) may be determined through analysis of the content of the webpage itself. For example, the subdivision citation attribute 514 indicates that the copied text came from the third paragraph of Chapter 19.

In one embodiment, an algorithm analyzes the webpage to determine that the selected text 501 was located in the third paragraph of text. For example, the algorithm could count the number of paragraphs by identifying groups of complete sentences between paragraph marks or line breaks, assign numbers to each paragraph, then determine which paragraph the copied material is in. Furthermore, an algorithm can be used to search the displayed (i.e. non-metadata) content of the webpage for terms describing subdivisions of text, such as “chapter”, “volume”, “part”, etc. For example, such an algorithm could search for the word “chapter” followed by a number (word or digit) in the webpage 580, and from this, derive the subdivision of the copied material.

For the date attribute 516, as in FIG. 3, the date reflects the date which the user visited the webpage and copied the text. Another metadata tag 515 may be used for the publication date, thereby allowing a webpage composer to embed the true publication date of the content of the webpage within the coding of the webpage. For example, a publication metadata tag for Voltaire's Candide would indicate a publication date of January 1759, and could be indicated in the copy buffer 502. This information could then be used in automatically generating a citation.

Upon receiving a paste command from the user, at least a portion of the contents of the copy buffer 502 are inserted into a specified location, such as a text document. In the embodiment illustrated, the paste result 530 presents the copied text 520 rendered in accordance with the conventional attributes 522. In addition, in one embodiment, the paste result 530 presents the copied material within quotes 532, to indicate that is was derived quoted from another source. A footnote reference 534 is associated with the pasted text. The footnote reference 534 refers to a corresponding footnote 536 that is also inserted.

In one embodiment, the formatting of the footnote 536 is in accordance with a specified user preference. For example, in the embodiment illustrated in FIG. 5, the footnote citation is formatted according to the MLA format. As such, each element of information in the footnote 536 is derived from the copy buffer 502, with the formatting automatically arranged according to the specified style.

In one embodiment, at least a portion (or all) of the citation information 540 for the pasted text 531 is maintained or preserved as metadata in the destination document. This allows for the citation information to be preserved and perpetuated over several copy/paste operations and across various documents. For example, consider the case where a user first copies text (“Text A”) from a webpage (“Source Document”) and pasted into a text document (“Document 1”). The citation information (whether visible/shown in the document or not) is preserved in Document 1 as metadata. At some point later, Document 1 is accessed and Text A is copied from Document 1 and then inserted into another document (“Document 2”). The citation information for Text A is also copied from Document 1 and transferred to the metadata for Document 2 when Text A is pasted into Document 2. As can be seen, this process could continue repeatedly, whereby the citation information is preserved in some form at each step. Thus, as use of the citation attribute becomes widespread, accurate citation information may easily be perpetuated. In one embodiment, the attributes for the copied information could include a “chain of title” allowing the source of the copied material to be traced across several documents, indicating the trail of documents from which the copied material was obtained.

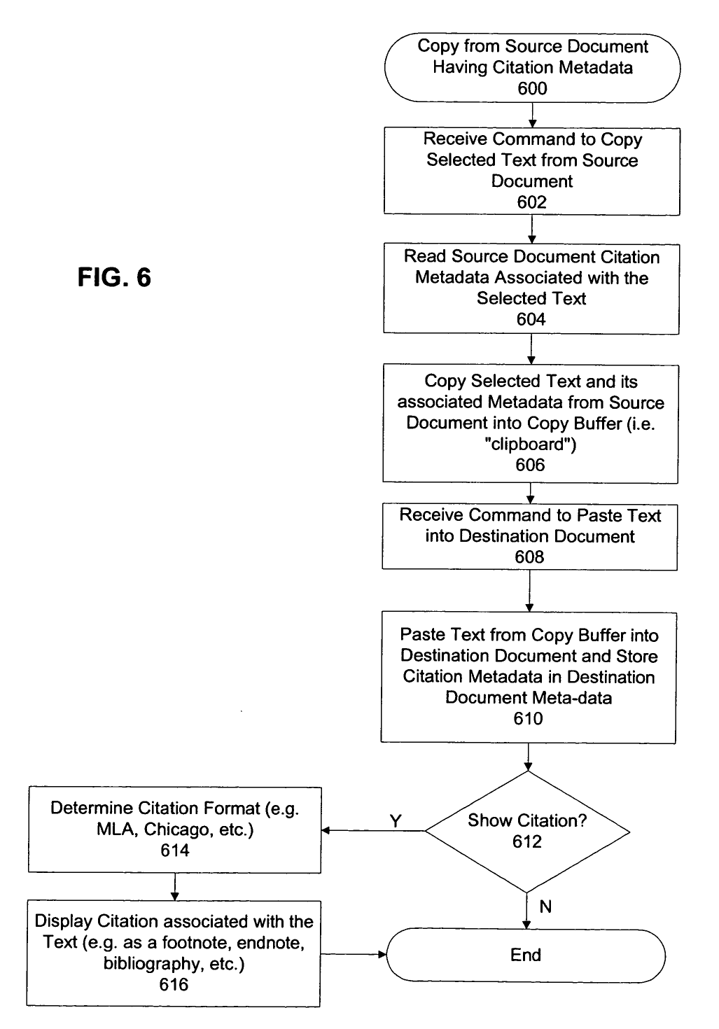

FIG. 6 illustrates an embodiment of a method 600 for copying data from a source document having citation metadata therein. In one embodiment, the method 600 may be used to generate the copy buffer and paste result of FIG. 5. At block 602, the method 600 receives a command to copy selected text from a source document. The source document may be any of various digital documents, such as text documents, webpage (e.g. HTML) documents, video data, image data, audio data, etc. At block 604, the method 600 reads citation metadata for the source document, such as for example metadata tags in a webpage describing characteristics of the webpage content (e.g. author, title, etc.), as described above with respect to FIG. 5. At block 606, the method 600 copies the selected text and the associated metadata from the source document into the copy buffer or clipboard. The copied citation metadata is stored in the copy buffer under corresponding citation attribute fields, as described above with respect to FIG. 5.

In an alternative embodiment, in addition to automatically copying citation metadata from the source document, the method 600 also may automatically copy other metadata of source document into the copy buffer. In an exemplary embodiment, a source document may include metadata describing some characteristic of the source document other than citation information, such as for example, metadata identifying the name and version of a default software application used to access the source document; in such a case, method 600 may automatically copy this metadata in addition to copying the citation metadata into the copy buffer. Thus, in one embodiment, metadata of the source document other than citation metadata may be automatically copied along with citation metadata. This metadata may then be inserted into a destination document (e.g. into the destination document's metadata), in a similar manner as described herein for the citation metadata. It will be appreciated that examples of metadata other than citation metadata that may be used with embodiments of the present invention are varied, and may include metadata that describes characteristics of the source document such as type of document, format of document, size of document, permissions associated with the document (e.g. read, write, execute), preferences associated with viewing the document, and user comments associated with the document, among others.

At block 608, the method 600 receives a command to paste the text into a destination document. At block 610, the method 600 pastes the text from the copy buffer into the destination document and stores the citation attribute information into the destination document as metadata. At block 612, the method 600 determines whether to show or display the citation information within the destination document. For example, a user may wish to display the citation for pasted text as a footnote; or alternatively, the user may not wish to display citation information for pasted text. If the method 600 determines that a citation is not to be shown at block 612, since the citation information is stored in the destination document's metadata, the citation information is preserved for later use. For example, a citation may be displayed later, or if the pasted material is subsequently copied, the associated metadata may be copied along with it, for dissemination to another destination document.

If the method 600 determines to show the citation at block 612, then at block 614, the method determines which format to display the citation information in, such as the MLA format, the Chicago Manual of Style format, etc. In one embodiment, the citation format is specified by a user, either prior to or upon issuing the paste command. Based on the determined format, a portion or all of the citation information from the citation attributes stored in the destination document's metadata may be used in generating the citation, such as a footnote or other citation convention, which is displayed in association with the pasted text at block 616. In one embodiment, the citation information is not necessarily directly associated with the pasted text, e.g. as a footnote; rather, the citation information is indirectly associated with the pasted text, such as through a bibliography of reference materials for the destination document.

In one embodiment, upon copying a portion of data from a source document, citation information for more than one source may be collected. By way of example, consider the situation where a user copies text from a webpage having content from multiple original sources, such as a webpage having a plurality of different quotes from various famous persons thereon. In one embodiment, if a user selects or highlights a portion of the content that includes two quotes from different persons, each quote has its own respective associated citation information (e.g. person quoted, reference to publication where quoted statement appeared, date of quote, etc.), citation information is automatically collected for both quotes. Thus, a copy buffer may include citation information describing multiple sources associated with the copied data. Furthermore, upon pasting the copied material, in one embodiment, multiple citations may be inserted, one for each quote. In an alternative embodiment, depending on the application and/or user preference, only one citation may be generated, for example, to merely cite the webpage from which the information was copied, rather than the original source of the copied quotes. It will be appreciated that embodiments of the invention are contemplated which may support simultaneous copying and gathering of citation information for data having a plurality of different sources.

It will be appreciated that although the embodiments described herein primarily refer to copy (or reproduce) operations, embodiments of the present invention may be implemented broadly with any type of operation in which data is written to a storage device (e.g. a store operation, a save operation, or downloading data). Embodiments of the present invention may also be implemented using other common commands or operations for collecting data into a clipboard, such as “Cut” or “Import” commands, or drag-and-drop operations using a pointing device. It will also be appreciated that embodiments of the present application may be implemented in any situation where content is copied and stored with citation information.

In addition, although embodiments of the invention described herein refer to a copy buffer, it will be appreciated that any type of buffer may be used with embodiments of the invention. As used herein, a buffer includes any storage mechanism (whether transitory or not) that is capable of storing copied data and its corresponding citation data. Further, although aspects of specific embodiments of the present invention have been described with reference to a copy buffer, it will be appreciated that in other embodiments, citation attributes may be directly transferred from a source document to a destination document without use of an intermediate buffer. For example, in one embodiment, data from a source may be directly saved to a destination file with the attendant metadata. In another exemplary embodiment, where data is copied, citation information for the data is not automatically collected upon receiving a copy command; instead, citation information for the copied data is automatically collected upon receiving a command to paste or insert the copied data to a destination. Thus, in one embodiment, the copy buffer may only contain the copied data, since the citation information is directly transferred from the source to the destination file. Alternatively, in another embodiment, the copy buffer may be bypassed altogether, and both the selected data and its citation information are transferred directly from the source document to the destination document upon receiving an insert command.

Furthermore, although embodiments of the invention have been described by reference to webpages for clarity, it should be appreciated that numerous other data sources are contemplated for implementation of embodiments of the invention. For example, citation information may automatically be collected upon copying data from other types of information sources, such as but not limited to, text documents, spreadsheets, binary files, portable document format (PDF) files, video data, image data, audio data, multimedia data, and any other type of digital information that can be cited. In addition, although embodiments of the invention have been described primarily with respect to copying data from files, embodiments of the invention may be applied to streaming, viewing, downloading or otherwise accessing non-file based sources of information, such as for example streams of information, such as audio, radio or video data streams.

In an exemplary embodiment involving video editing, a user may copy or cut a clip of video, upon which citation information for the source of the clip is automatically collected, such as by reading metadata for the source video file. Citation information that is collected from the video file may include the timestamps of the beginning and end of the copied clip, among other citation information that may be available in the source file. Other metadata, in addition to citation metadata, may also be automatically collected. Subsequently, when the user pastes the clip into a destination file, the citation information (and any other collected metadata) is also inserted into or associated with the destination file. For example, citation information may be added to metadata for the destination video file, indicating that the sequence from 1 min 30 seconds to 3 minutes was derived from a video stream authored by a particular person. In one embodiment, other multimedia content, such as audio files or stream (e.g. music, radio, speech) may be handled in a similar manner as described above for video.

In an exemplary embodiment involving copying image data, such as for example a (Joint Photographic Experts Group) JPEG file, upon copying a JPEG image, metadata in addition to any citation metadata is automatically collected when copying the file, for alter use when inserting the copied image data into a destination. For example, for an image, such metadata may include including shooting conditions (e.g. whether a flash was used when capturing the image), camera settings (shutter, aperture, focal length), GPS coordinates of the location where the image was captured, etc. For example, camera-embedded metadata called EXIF (Exchangeable Image File Format) specifies other types of metadata and its format that may be used with embodiments of the present invention.

Further, although the examples described above refer to URLs for webpages, other embodiments may use other identifiers for the source of information available on a network (e.g. the Internet) is contemplated, such as Uniform Resource Identifiers (URI). URIs specify the name and address syntax of present and future objects on the Internet. URI is the umbrella term for Uniform Resource Names (URN), URLs, and all other Uniform Resource Identifiers.

In one embodiment, in place of, or in addition to, storing citation information in metadata for a destination document, citation information for a pasted selection of data may be stored in a system-wide log or repository (e.g. database) of metadata on a computing system. In one embodiment, a system process tracks all copy and paste operations across various user applications, creating an audit trail of citation data for all copied/pasted data. Further, the system may automatically, upon saving the destination file, automatically update the metadata database to include a metadata file for the destination file, which metadata file contains the citation data which was automatically collected. This repository of citation information has various uses. For example, in one embodiment, where a user attempts to paste copied material into an application that does not support the automatic insertion of citation information as described above, the citation information for the pasted material may be stored in a system-log of metadata that is independent of the pasted-to application, and the system-wide log of metadata may, in certain exemplary embodiments, be searchable. This would allow a user to later consult the system log and manually add the citation information into the document. Thus the citation information would still be preserved on the user's system, despite having attempted to paste the material into an application not supporting the automatic insertion of citation attributes. Additionally, in one embodiment, a user could use the system-wide metadata log to assign additional citation information or modify existing citation information for copied/pasted data.

The system-wide metadata database, at least in certain embodiments, contains metadata from a plurality of different files which represent different types of files. For example, the metadata in the metadata database may be from word processing files (e.g. a “.doc” or a “.txt” or a “.rtf” file), JPEG (or other image) files, PDF (portable document format) files, mp3 (or other audio) files, spreadsheet files (e.g. “.xls”), presentation files (e.g. “.ppt” files), webpage files (e.g. “.html”), etc. These files normally have different types of data in their metadata, so the metadata database includes metadata of different types such that the type of metadata of one type of file is different than the type of metadata for another type of file. The metadata database may be maintained by one or more operating system level software components which automatically, in response to a user insertion, update the destination file's record in the metadata database with the citation information which was automatically captured from the source file. Additional details regarding metadata and associated databases that may be used with certain embodiments of the invention may be found in U.S. patent application Ser. No. 10/877,584 entitled “METHODS AND SYSTEM FOR MANAGING DATA,” filed Jun. 25, 2004, the contents of which are incorporated by reference herein.

In one embodiment, pastes or insertions within a document and their associated citation metadata may be verified. For example, a citation for copied/pasted text which was entirely automatically generated by a computerized algorithm (i.e. the user did not manually input or alter the citation information such as author, URL, etc.) may be identified as verified or authenticated, such as by assigning a checksum or hash value to the copied text and its associated attribute information. A verified citation is useful when the copied text is disseminated to other various documents, as a subsequent user can assign a certain level of trustworthiness to a verified citation, as its verified status indicates that a user has not tampered with or altered the citation information as it was originally automatically collected. Additionally, a service mark or other identifying characteristic could be associated with a document including verified pastes (i.e. pasted data for which the citation attributes are believed to be accurate).

It will be appreciated that embodiments of the present invention will have applicability to various fields of use. It will be readily apparent that embodiments of the present invention described herein may be applied to the literary, journalism, publishing, print, education, scientific, research, and legal fields, among others. In one embodiment, for example, at least a portion of method 600, described above with respect to FIG. 6, may be applied to quoting a portion of a published judicial opinion or other legal document presented on a webpage. In an exemplary embodiment, a user may access a webpage displaying text of a published judicial opinion or case. After highlighting or selecting a portion of text from the opinion (e.g. a sentence reciting the holding of the case), the user issues a command to copy the highlighted text (in one embodiment, the copy command may be simultaneous with the highlighting or selecting). Upon receiving the command to copy the highlighted sentence, the method automatically copies a citation for the judicial opinion from either the metadata of the webpage (e.g. a meta tag specifying the case caption and citation, such as “MARBURY v. MADISON, 5 U.S. 137”), or by recognizing a case citation from the content of the webpage itself. In one embodiment, a page number for the copied sentence may also be automatically copied into the copy buffer, such as by analyzing the content of the webpage in relation to the copied portion, and determining a page number of the opinion corresponding to the copied portion. Thus, in one embodiment, after copying a portion of the content from a webpage, citation information is automatically collected without further user interaction required.

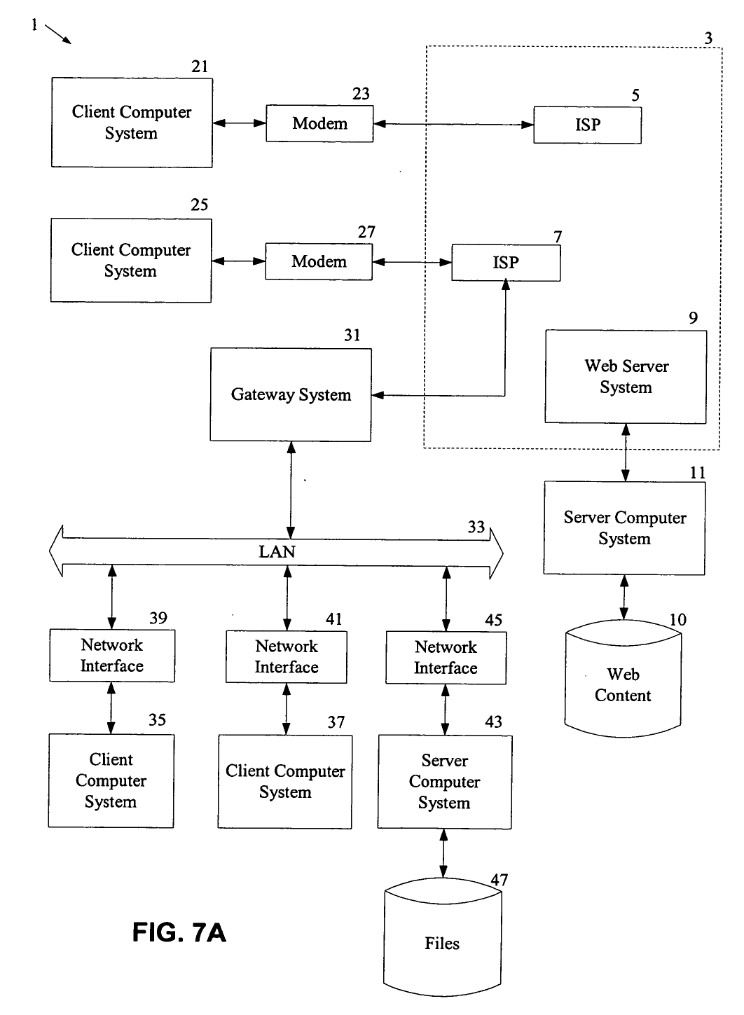

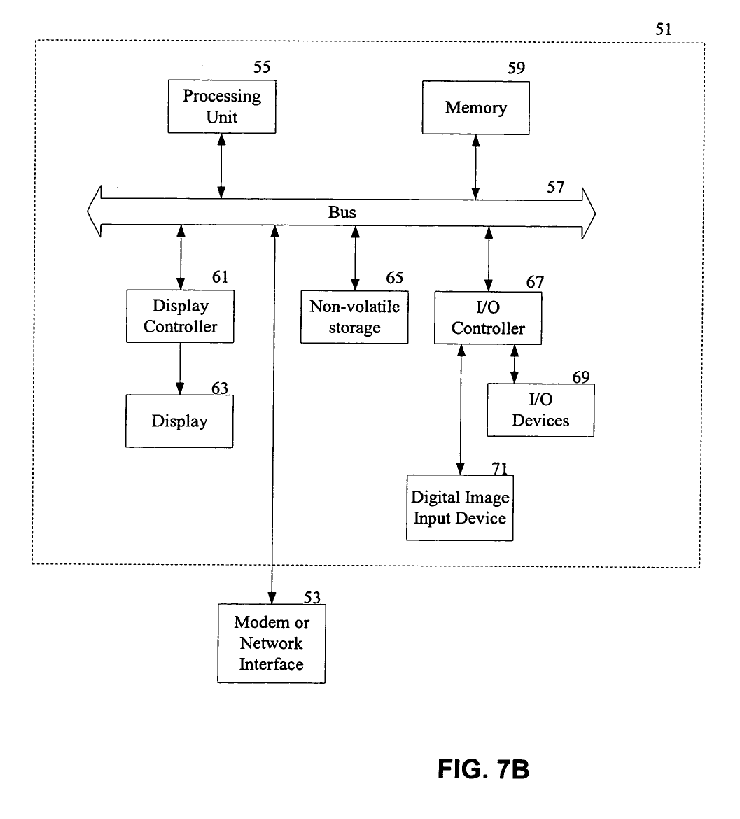

The following description of FIGS. 7A and 7B is intended to provide an overview of computer hardware and other operating components suitable for implementing embodiments of the invention described herein, but is not intended to limit the applicable environments. One of skill in the art will immediately appreciate that the invention can be practiced with other computer system configurations, including hand-held devices, cellular telephones, multiprocessor systems, microprocessor-based or programmable consumer electronics/appliances, network PCs, minicomputers, mainframe computers, and the like. Embodiments of the invention can also be practiced in distributed computing environments where tasks are performed by remote processing devices that are linked through a communications network.

FIG. 7A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems, such as client computer systems 21, 25, 35, and 37 obtain access to the Internet through the Internet service providers, such as ISPs 5 and 7. Access to the Internet allows users of the client computer systems to exchange information, receive and send emails and instant messages, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 7A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, consumer electronics/appliance, a network computer, a Web TV system, a handheld device, or other such computer system. Similarly, the ISP 7 provides Internet connectivity for client systems 25, 35, and 37, although as shown in FIG. 7A, the connections are not the same for these three computer systems. Client computer system 25 is coupled through a modem interface 27 while client computer systems 35 and 37 are part of a LAN. While FIG. 7A shows the interfaces 23 and 27 as generically as a “modem,” it will be appreciated that each of these interfaces can be an analog modem, ISDN modem, DSL modem, cable modem, satellite transmission interface, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 7B shows one example of a conventional computer system that can be used as a client computer system or a server computer system or as a web server system, for use with embodiments of the present invention The computer system of FIG. 7B may, for example, be an Apple Macintosh® computer. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, DSL modem, cable modem, token ring interface, satellite transmission interface, or other interfaces for coupling a computer system to other computer systems. The computer system 51 includes a processing unit 55, which can be a conventional microprocessor such as a G3, G4, or G5 microprocessor from Motorola, Inc. or IBM, a Motorola Power PC® microprocessor, or an Intel® Pentium® microprocessor. Memory 59 is coupled to the processor 55 by a bus 57. Memory 59 can be dynamic random access memory (DRAM) and can also include static RAM (SRAM), among other types of well-known memory devices. The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the terms “computer-readable medium” and “machine-readable medium” include any type of storage device that is accessible by the processor 55 or other data processing system such as a cellular or mobile telephone or a personal digital assistant or an MP3 player, and also encompass a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processor 55. A Web TV system, which is known in the art, is also considered to be a computer system according to the present invention, but it may lack some of the features shown in FIG. 7B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. One example of an operating system software with its associated file management system software is the family of operating systems known as Mac OS® operating system from Apple Computer, Inc. of Cupertino, Calif., and their associated file management systems. The file management system is typically stored in the non-volatile storage 65 and causes the processor 55 to execute the various acts required by the operating system to input and output data and to store data in memory, including storing files on the non-volatile storage 65.

The methods described above constitute computer programs made up of computer-executable instructions illustrated as blocks (acts) within the flow charts of FIGS. 4 and 6. Describing the methods by reference to a flow chart enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the methods illustrated in FIGS. 4 and 6 without departing from the scope of the invention and that no particular order is implied by the arrangement of blocks shown and described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. For example, in certain embodiments, the data may be selected from a source file and inserted into a destination file without using a copy buffer or “clipboard.” The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A machine-implemented method comprising:
receiving a command to copy or cut data from a source;
in response to receiving the command to copy or cut the data, automatically collecting citation information associated with the data; and
copying the data and the citation information into a copy buffer.

2. The method of claim 1, wherein the citation information is stored in the copy buffer as attributes for the copied data.

3. The method of claim 1, wherein the citation information includes information selected from the group consisting of an author, a composer, a title, a date, a time, a publisher, a uniform resource locator (URL), and a subsection.

4. The method of claim 1, wherein the data is selected by a user, and wherein the data is selected from the group consisting of text, image, audio, and video data.

5. The method of claim 1, further comprising:
receiving a command to insert the data into a destination file; and
in response to receiving the command to insert, automatically transferring the data and its associated citation information from the copy buffer into the destination file.

6. An apparatus comprising:
means for receiving a command to copy or cut data from a source;
means for automatically collecting citation information associated with the data in response to receiving the command to copy or cut the data; and
means for copying the data and the citation information into a copy buffer.

7. The apparatus of claim 6, wherein the data is selected by a user, and wherein the data is selected from the group consisting of text, image, audio, and video data.

8. The apparatus of claim 6, further comprising:
means for receiving a command to insert the data into a destination file; and
means for automatically transferring the data and its associated citation information from the copy buffer into the destination file in response to receiving the command to insert.

9. A machine-readable medium having instructions to cause a machine to perform a machine-implemented method comprising:
receiving a command to copy or cut data from a source;
in response to receiving the command to copy or cut the data, automatically collecting citation information associated with the data; and
copying the data and the citation information into a copy buffer.

10. The machine-readable medium of claim 9, wherein the citation information includes information selected from the group consisting of an author, a composer, a title, a date, a time, a publisher, a uniform resource locator (URL), and a subsection.

11. The machine-readable medium of claim 9, wherein the method further comprises:
receiving a command to insert the data into a destination file; and
in response to receiving the command to insert, automatically transferring the data and its associated citation information from the copy buffer into the destination file.

12. A system comprising:
a processing unit coupled to a memory through a bus; and
a process executed from the memory by the processing unit to cause the processing unit to:
receive a command to copy or cut data from a source;
in response to receiving the command to copy or cut the data, automatically collect citation information associated with the data; and
copy the data and the citation information into a copy buffer.

13. The system of claim 12, wherein the citation information includes information selected from the group consisting of an author, a composer, a title, a date, a time, a publisher, a uniform resource locator (URL), and a subsection.

14. The system of claim 12, wherein the process further causes the processing unit to:
receive a command to insert the data into a destination file; and
in response to receiving the command to insert, automatically transfer the data and its associated citation information from the copy buffer into the destination file.

15. A machine-implemented method comprising:
receiving a command to obtain data from a source file;
in response to receiving the command to obtain the data, automatically collecting citation information associated with the data;
receiving a command to insert the data into a destination file; and
in response to receiving the command to insert, automatically inserting the data into the destination file.

16. The method of claim 15, further comprising displaying at least a portion of the citation information within the destination file, wherein the portion of the citation information is formatted according to a user-specified citation convention.

17. The method of claim 15, further comprising storing the citation information in a record of a metadata database, the storing of the citation information occurring automatically in response to either the inserting or a storing of the destination file.

18. The method of claim 17, wherein the metadata database contains metadata from a plurality of files stored on a storage device which stores the destination file and wherein, in the metadata databases, the types of metadata for one type of file is different than the type of metadata for another type of file.

19. An apparatus comprising:
means for receiving a command to obtain data from a source file;
means for automatically collecting citation information associated with the data in response to receiving the command to obtain the data;
means for receiving a command to insert the data into a destination file; and
means for automatically inserting the data into the destination file in response to receiving the command to insert.

20. The apparatus of claim 19, further comprising means for displaying at least a portion of the citation information within the destination file, wherein the portion of the citation information is formatted according to a user-specified citation convention.

21. A machine-readable medium having instructions to cause a machine to perform a machine-implemented method comprising:
receiving a command to obtain data from a source file;
in response to receiving the command to obtain the data, automatically collecting citation information associated with the data;
receiving a command to insert the data into a destination file; and
in response to receiving the command to insert, automatically inserting the data into the destination file.

22. The machine-readable medium of claim 21, wherein the method further comprises:
storing the citation information in a record of a metadata database, the storing of the citation information occurring automatically in response to either the inserting or a storing of the destination file.

23. The machine-readable medium of claim 22, wherein the metadata database contains metadata from a plurality of files stored on a storage device which stores the destination file and wherein, in the metadata databases, the types of metadata for one type of file is different than the type of metadata for another type of file.

24. A machine-implemented method comprising:
receiving a command to store data;
in response to receiving the command to store the data, automatically collecting citation information for the data; and
storing the data and the collected citation information.

25. The method of claim 24, wherein a source of the data is a webpage, and meta tags within the coding of the webpage specify at least a portion of the citation information.

26. The method of claim 24, further comprising:
storing the data and the collected citation information in a destination file; and
displaying at least a portion of the citation information within the destination file, wherein the portion of the citation information is formatted according to a user-specified citation convention.

27. The method of claim 26, wherein the data is text, and wherein the portion of the citation information is displayed as a reference associated with the stored data within the destination file.

28. The method of claim 27, wherein the reference is selected from the group consisting of a footnote, endnote, and a parenthetical citation.

29. An apparatus comprising:
means for receiving a command to store data;
means for automatically collecting citation information for the data in response to receiving the command to store the data; and
means for storing the data and the collected citation information.

30. The apparatus of claim 29, wherein a source of the data is a webpage, and meta tags within the coding of the webpage specify at least a portion of the citation information.

31. The apparatus of claim 29, further comprising:
means for storing the data and the collected citation information in a destination file; and
means for displaying at least a portion of the citation information within the destination file, wherein the portion of the citation information is formatted according to a user-specified citation convention.

32. A machine-readable medium having instructions to cause a machine to perform a machine-implemented method comprising:
receiving a command to store data;
in response to receiving the command to store the data, automatically collecting citation information for the data; and
storing the data and the collected citation information.

33. The machine-readable medium of claim 32, wherein the method further comprises:
storing the data and the collected citation information in a destination file; and
displaying at least a portion of the citation information within the destination file, wherein the portion of the citation information is formatted according to a user-specified citation convention.

34. The machine-readable medium of claim 33, wherein the data is text, and wherein the portion of the citation information is displayed as a reference associated with the stored data within the destination file.

35. A machine-implemented method comprising:
receiving a command to copy data from a source;
in response to receiving the command to copy the data, automatically collecting metadata associated with the source;
receiving a command to insert the data into a destination; and
in response to receiving the command to insert, automatically inserting the data and the metadata into the destination.

36. The method of claim 35, wherein the metadata includes citation information for the source.

37. The method of claim 35, further comprising copying the data and the metadata into a copy buffer.

38. An apparatus comprising:
means for receiving a command to copy data from a source;
means for, in response to receiving the command to copy the data, automatically collecting metadata associated with the source;
means for receiving a command to insert the data into a destination; and
means for, in response to receiving the command to insert, automatically inserting the data and the metadata into the destination.

39. The apparatus of claim 38, wherein the metadata includes citation information for the source.

40. A machine-implemented method comprising:
receiving a command to insert data into a destination file, the data having been copied from a source; and
in response to receiving the command to insert the data, inserting the data and citation information associated with the data into the destination file.

41. The method of claim 40, the citation information having been automatically collected from the source in response to a command to copy the data.

42. The method of claim 40, further comprising:
in response to receiving the command to insert the data, automatically collecting the citation information for the data from the source.

43. The method of claim 42, wherein the citation information includes information selected from the group consisting of an author, a composer, a title, a date, a time, a publisher, a uniform resource locator (URL), and a subsection.

44. A system comprising:
a processing unit coupled to a memory through a bus; and
a process executed from the memory by the processing unit to cause the processing unit to:
receive a command to insert data into a destination file, the data having been copied from a source; and
in response to receiving the command to insert the data, insert the data and citation information associated with the data into the destination file.

45. The system of claim 44, wherein the process further causes the processing unit to:
in response to receiving the command to insert the data, automatically collect the citation information for the data from the source.

46. A machine-implemented method for providing an interface between a first software component and a second software component, the method comprising:
the first software component receiving a command to copy selected data from a source file; and
the second software component, in response to the command to copy, automatically collecting citation information for the selected data.

47. The method of claim 46, further comprising:
the first software component copying the selected data from the source file to a copy buffer; and
the second software component copying the citation information to the copy buffer.

48. The method of claim 47, further comprising:
the first software component receiving a command to insert the copied data into a destination file;
in response to the command to insert, the second software component inserting the data and the citation information into the destination file.
